(19) United States
(12) Patent Application Publication
(10) Pub. No.: US 2025/0092168 A1
(43) Pub. Date: Mar. 20, 2025

(54) HIGHLY FUNCTIONALIZED STABLE DIHYDROCARBYLOXYSILYL POLYDIENES AND POLYDIENE COPOLYMERS

(71) Applicant: Bridgestone Americas Tire Operations, LLC, Nashville, TN (US)

(72) Inventors: Jeffrey A. CICERCHI, Akron, OH (US); Gabrielle L. MCINTYRE, Akron, OH (US); Terrence E. HOGAN, Uniontown, OH (US)

(21) Appl. No.: 18/727,099

(22) PCT Filed: Jan. 9, 2023
(86) PCT No.: PCT/US2023/060320

§ 371 Date: Jul. 7, 2024

Related U.S. Application Data
(60) Provisional application No. 63/297,375, filed on Jan. 7, 2022.

(51) Int. Cl. C08F 8/42; C08K 3/36

(52) U.S. Cl. CPC C08F 8/42; C08K 3/36; C08F 2810/40

(57) ABSTRACT

A polymeric composition comprising a plurality of hydrocarbyloxysilyl-terminated polydienes or polydiene copolymers, the polymeric composition having an aged Mooney (ML₁₊₄@100° C.) of about 40 to about 105, where the polymeric composition includes from about 10 to about 95 mole % of said hydrocarbyloxysilyl-terminated polydienes or polydiene copolymers, where said hydrocarbyloxysilyl-terminated polydienes or polydiene copolymers are formed by reacting reactive polydienes or polydiene copolymers with a dihydrocarbyloxysilyl terminating agent.

### FIELD OF THE INVENTION

Embodiments of the present invention are directed toward dihydrocarbyloxysilyl-functionalized polydienes and polydiene copolymers that are characterized by high functionality and long-term stability against deleterious Mooney growth.

### BACKGROUND OF THE INVENTION

In the manufacture of tires, especially tire treads, it is known to employ modified polymers, such as those including end functionalization. It has been observed that rubber vulcanizates prepared with these modified polymers exhibit reduced hysteretic loss and show reduced Payne effect, which is the loss of mechanical energy resulting from filler deagglomeration.

Polymer modification is often achieved by reacting a living polymer species with a compound that can impart a functional group to the end of the polymer chain. For example, U.S. Pat. No. 6,369,167 teaches preparing diene polymer, such as random copolymers of butadiene and styrene, through anionic polymerization techniques, and then terminating the polymer with an imine-containing hydrocarbyloxy silane compound. The terminating compound, which is also referred to as a terminal modifier, is employed in amounts from 0.25 to 3 mole per mole of organolithium compound used to initiate the anionic polymerization.

Similar terminal modifiers are disclosed in U.S. Pat. No. 7,683,151, which teaches using 0.3 mol equivalent or more based on the apparent active site. Following the modification reaction, this patent teaches the addition of a condensation accelerator (e.g., a tin carboxylate) to effect condensation (which yields polymer coupling) of the hydrocarbyloxy silane residue at the polymer chain end. After finishing, the resultant modified polymer has a Mooney viscosity (ML₁+4@100° C.) of 10 to 150.

The hydrocarbyloxy silane residue has been found to cause increases in aged Mooney viscosity, which increases are believed to result from coupling that occurs between functional polymers in the presence of water. This coupling is believed to be initiated when water hydrolyzes a hydrocarbyloxy silane substituent to form a siloxy substituent, and then the siloxy substituent of respective polymers undergo condensation to effect coupling. U.S. Pat. No. 6,255,404 teaches a remedy to this Mooney viscosity increase by treating the modified polymers with an alkyl alkoxysilane (e.g., octyl triethoxy silane) to thereby stabilize the hydrocarbyloxy silane end group. The alkyl alkoxysilane can be added in amounts from 1 to 20 mol per mole of initiator, although when present in amounts above the equivalence of alkoxysilane functionalities, decreases in polymer viscosity are observed due to the plasticizing effect of the alkyl alkoxysilane (i.e., the excess alkyl alkoxysilane acts as an oil).

### SUMMARY OF THE INVENTION

One or more embodiments of the present invention provide a polymeric composition comprising a plurality of hydrocarbyloxysilyl-terminated polydienes or polydiene copolymers, the polymeric composition having an aged Mooney (ML₁₊₄@100° C.) of about 40 to about 105, where the polymeric composition includes from about 10 to about 95 mole % of said hydrocarbyloxysilyl-terminated polydienes or polydiene copolymers, where said hydrocarbyloxysilyl-terminated polydienes or polydiene copolymers are formed by reacting reactive polydienes or polydiene copolymers with a terminating agent defined by the formula:

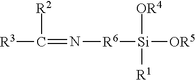

where R¹, R², R³, R⁴, and R⁵ are each individually a hydrocarbyl group, and R⁶ is a dihydrocarbyl group.

Other embodiments of the present invention provide a method for preparing a functionalized polydiene or polydiene copolymer polymeric composition, the method comprising reacting reactive polydienes or polydiene copolymers with a terminating agent defined by the formula:

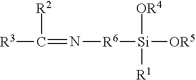

where R¹, R², R³, R⁴, and R⁵ are each individually a hydrocarbyl group, and R⁶ is a dihydrocarbyl group to thereby form a functionalized polydienes or polydiene copolymers.

Yet other embodiments of the present invention provide a vulcanizable rubber composition comprising (i) a functionalized polydiene or polydiene copolymer formed by reacting reactive polydienes or polydiene copolymers with a terminating agent defined by the formula:

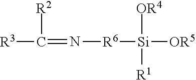

where R¹, R², R³, R⁴, and R⁵ are each individually a hydrocarbyl group, and R⁶ is a dihydrocarbyl group; (ii) a silica filler; and (iii) a curative.

Still other embodiments of the present invention provide a vulcanizate prepared by vulcanizing the vulcanizable composition comprising (i) a functionalized polydiene or polydiene copolymer formed by reacting reactive polydienes or polydiene copolymers with a terminating agent defined by the formula:

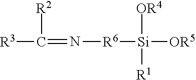

where R¹, R², R³, R⁴, and R⁵ are each individually a hydrocarbyl group, and R⁶ is a dihydrocarbyl group; (ii) a silica filler; and (iii) a curative.

### DETAILED DESCRIPTION OF ILLUSTRATIVE EMBODIMENTS

Embodiments of the invention are based, at least in part, on the discovery of a process for producing hydrocarbyloxysilyl-functionalized polydienes and polydiene copolymers that are characterized by desirable rheological properties (e.g. Mooney viscosity) and give rise to rubber vulcanizates with advantageous dynamic properties. While the prior art contemplates hydrocarbyloxysilyl-functionalized polydiene and polydiene copolymers and their use in rubber vulcanizates, the utility of these functionalized polymers has been frustrated by their time dependent rheological properties, which has necessitated the use of stabilizing agents. It has been observed that the degree of functionalization (e.g. using a imine-containing hydrocarbyloxy silanes) is directly proportional to the amount of stabilizing agent needed (e.g. use of octyl triethoxy silane), and that the tradeoff between functionalization and stabilization usage favors lowers levels of functionalization from the standpoint of polymer processing. At lower levels of functionalization, however, potential benefits in vulcanizate properties are believed to be sacrificed. The present invention provides the unexpected benefit of desirable rheological properties and improved dynamic properties over conventionally used technologies.

### Preparation of Dihydrocarbyloxysilyl-Functionalized Polydienes

In one or more embodiments, the hydrocarbyloxysilyl-functionalized polydienes and polydiene copolymers, which may also be referred to as functionalized hydrocarbyloxysilyl polydienes and polydiene copolymers, are prepared by (i) anionically synthesizing reactive polydienes and/or polydiene copolymers, (ii) reacting the reactive polydienes and/or polydiene copolymers with a dihydrocarbyloxysilyl functionalizing agent to thereby form functionalized hydrocarbyloxysilyl polydienes and/or polydiene copolymers, (iii) optionally treating the functionalized hydrocarbyloxysilyl polydienes and/or polydiene copolymers with a stabilizing agent, and (iv) isolating the functionalized hydrocarbyloxysilyl polydienes and/or polydiene copolymers. As used herein, hydrocarbyloxysilyl-functionalized polydienes or hydrocarbyloxysilyl-terminated polydienes or copolymers refer to those polydienes and/or copolymers that have been functionalized with dihydrocarbyloxysilyl-functionalizing agents.

### Anionically Synthesizing a Reactive Polydiene

In one or more embodiments, reactive polydienes and polydiene copolymers are prepared by anionically polymerizing diene monomer optionally together with monomer copolymerizable therewith. In one or more embodiments, polymerization includes anionically polymerizing conjugated diene monomer (e.g., butadiene) and vinyl aromatic monomer (e.g., styrene) in solution to provide a polymerization mixture including polydiene polymers and copolymers having reactive polymer chain ends.

The preparation of polymer by employing anionic polymerization techniques is generally known. The key mechanistic features of anionic polymerization have been described in books (e.g., Hsieh, H. L.; Quirk, R. P. Anionic Polymerization: Principles and Practical Applications; Marcel Dekker: New York, 1996) and review articles (e.g., Hadjichristidis, N.; Pitsikalis, M.; Pispas, S.; Iatrou, H.; Chem. Rev. 2001, 101(12), 3747-3792). Anionic initiators may advantageously produce polymer having reactive chain ends (e.g., living polymers) that, prior to quenching, are capable of reacting with additional monomers for further chain growth or reacting with certain functionalizing agents to give functionalized polymers. The polymers having reactive polymer chain ends may simply be referred to as reactive polymers. As those skilled in the art appreciate, these reactive polymers include a reactive chain end, which is believed to be ionic, at which a reaction between a functionalizing agent and the reactive chain end of the polymer can take place, which thereby imparts a functionality or functional group to the polymer chain end, or which may couple multiple polymers together.

The monomer that can be anionically polymerized to form these polymers include conjugated diene monomer, which may optionally be copolymerized with other monomers such as vinyl-substituted aromatic monomer. Examples of conjugated diene monomer include 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, and 2,4-hexadiene. Mixtures of two or more conjugated dienes may also be utilized in copolymerization. Examples of monomer copolymerizable with conjugated diene monomer include vinyl-substituted aromatic compounds such as styrene, p-methylstyrene, α-methylstyrene, and vinylnaphthalene.

The practice of this invention is not limited by the selection of any particular anionic initiators. Exemplary anionic initiators include organolithium compounds. In one or more embodiments, organolithium compounds may include heteroatoms. In these or other embodiments, organolithium compounds may include one or more heterocyclic groups. Types of organolithium compounds include alkyllithium compounds, aryllithium compounds, and cycloalkyllithium compounds. Specific examples of organolithium compounds include ethyllithium, n-propyllithium, isopropyllithium, n-butyllithium, sec-butyllithium, t-butyllithium, n-amyllithium, isoamyllithium, and phenyllithium. Still other anionic initiators include organosodium compounds such as phenylsodium and 2,4,6-trimethylphenylsodium.

Anionic polymerization may be conducted in polar solvents, non-polar solvents, and mixtures thereof. In one or more embodiments, a solvent may be employed as a carrier to either dissolve or suspend the initiator in order to facilitate the delivery of the initiator to the polymerization system.

In one or more embodiments, suitable solvents include those organic compounds that will not undergo polymerization or incorporation into propagating polymer chains during the polymerization of monomer in the presence of catalyst. In one or more embodiments, these organic species are liquid at ambient temperature and pressure. In one or more embodiments, these organic solvents are inert to the catalyst. Exemplary organic solvents include hydrocarbons with a low or relatively low boiling point such as aromatic hydrocarbons, aliphatic hydrocarbons, and cycloaliphatic hydrocarbons. Non-limiting examples of aromatic hydrocarbons include benzene, toluene, xylenes, ethylbenzene, diethylbenzene, and mesitylene. Non-limiting examples of aliphatic hydrocarbons include n-pentane, n-hexane, n-heptane, n-octane, n-nonane, n-decane, isopentane, isohexanes, isopentanes, isooctanes, 2,2-dimethylbutane, petroleum ether, kerosene, and petroleum spirits. And, non-limiting examples of cycloaliphatic hydrocarbons include cyclopentane, cyclohexane, methylcyclopentane, and methylcyclohexane. Mixtures of the above hydrocarbons may also be used. The low-boiling hydrocarbon solvents are typically separated from the polymer upon completion of the polymerization. Other examples of organic solvents include high-boiling hydrocarbons of high molecular weights, such as paraffinic oil, aromatic oil, or other hydrocarbon oils that are commonly used to oil-extend polymers. Since these hydrocarbons are non-volatile, they typically do not require separation and remain incorporated in the polymer.

Anionic polymerization may be conducted in the presence of a randomizer (which may also be referred to as a polar coordinator) or a vinyl modifier. As those skilled in the art appreciate, these compounds, which may serve a dual role, can assist in randomizing comonomer throughout the polymer chain and/or modify the vinyl content of the mer units deriving from dienes. Compounds useful as randomizers include those having an oxygen or nitrogen heteroatom and a non-bonded pair of electrons. Examples include linear and cyclic oligomeric oxolanyl alkanes; dialkyl ethers of mono and oligo alkylene glycols (also known as glyme ethers); “crown” ethers; tertiary amines; linear THF oligomers; and the like. Linear and cyclic oligomeric oxolanyl alkanes are described in U.S. Pat. Nos. 4,429,091 and 9,868,795, which are incorporated herein by reference. Specific examples of compounds useful as randomizers include 2,2-bis(2′-tetrahydrofuryl)propane, 1,2-dimethoxyethane, N,N,N′,N′-tetramethylethylenediamine (TMEDA), tetrahydrofuran (THF), 1,2-dipiperidylethane, dipiperidylmethane, hexamethylphosphoramide, N-N′-dimethylpiperazine, diazabicyclooctane, dimethyl ether, diethyl ether, tri-n-butylamine, and mixtures thereof. In other embodiments, potassium alkoxides can be used to randomize the styrene distribution.

The amount of randomizer to be employed may depend on various factors such as the desired microstructure of the polymer, the ratio of monomer to comonomer, the polymerization temperature, as well as the nature of the specific randomizer employed. In one or more embodiments, the amount of randomizer employed may range between 0.01 and 100 moles per mole of the anionic initiator.

The anionic initiator and the randomizer can be introduced to the polymerization system by various methods. In one or more embodiments, the anionic initiator and the randomizer may be added separately to the monomer to be polymerized in either a stepwise or simultaneous manner.

As indicated above, polymerization of conjugated diene monomer, together with monomer copolymerizable with the conjugated diene monomer, in the presence of an effective amount of initiator, produces a reactive polymer. The introduction of the initiator, the conjugated diene monomer, the comonomer, and the solvent forms a polymerization mixture in which the reactive polymer is formed. Polymerization within a solvent produces a polymerization mixture in which the polymer product is dissolved or suspended in the solvent. This polymerization mixture may be referred to as a polymer cement.

The amount of the initiator to be employed may depend on the interplay of various factors such as the type of initiator employed, the purity of the ingredients, the polymerization temperature, the polymerization rate and conversion desired, the molecular weight desired, and many other factors. In one or more embodiments, the amount of initiator employed may be expressed as the mmols of initiator per weight of monomer. In one or more embodiments, the initiator loading may be varied from about 0.05 to about 50 mmol, in other embodiments from about 0.1 to about 25 mmol, in still other embodiments from about 0.2 to about 2.5 mmol, and in other embodiments from about 0.4 to about 0.7 mmol of initiator per 100 gram of monomer.

In one or more embodiments, the polymerization may be conducted in any conventional polymerization vessel known in the art. For example, the polymerization can be conducted in a conventional stirred-tank reactor. In one or more embodiments, all of the ingredients used for the polymerization can be combined within a single vessel (e.g., a conventional stirred-tank reactor), and all steps of the polymerization process can be conducted within this vessel. In other embodiments, two or more of the ingredients can be pre-combined in one vessel and then transferred to another vessel where the polymerization of monomer (or at least a major portion thereof) may be conducted. Because various embodiments of the present invention include the use of multiple reactors or reaction zones, the vessel (e.g., tank reactor) in which the polymerization is conducted may be referred to as a first vessel or first reaction zone.

The polymerization can be carried out as a batch process, a continuous process, or a semi-continuous process. In the semi-continuous process, the monomer is intermittently charged as needed to replace that monomer already polymerized. In one or more embodiments, the heat of polymerization may be removed by external cooling by a thermally controlled reactor jacket, internal cooling by evaporation and condensation of the monomer through the use of a reflux condenser connected to the reactor, or a combination of the two methods. Also, conditions may be controlled to conduct the polymerization under a pressure of from about 0.1 atmosphere to 50 atmospheres, in other embodiments from about 0.5 atmosphere to about 20 atmosphere, and in other embodiments from about 1 atmosphere to about 10 atmospheres. In one or more embodiments, the pressures at which the polymerization may be carried out include those that ensure that the majority of the monomer is in the liquid phase. In these or other embodiments, the polymerization mixture may be maintained under anaerobic conditions.

### Temperature of Polymerization

In one or more embodiments, the conditions under which the polymerization proceeds may be controlled to maintain the peak polymerization temperature of the polymerization mixture at greater than 30° C., in other embodiments greater than 50° C., and in other embodiments greater than 70° C. In these or other embodiments, the conditions under which the polymerization proceeds may be controlled to maintain the peak polymerization temperature of the polymerization mixture at less than 120° C., in other embodiments less than 110° C., and in other embodiments less than 100° C. In one or more embodiments, the conditions under which the polymerization proceeds may be controlled to maintain the temperature of the polymerization mixture within a range from about −10° C. to about 200° C., in other embodiments from about 0° C. to about 150° C., and in other embodiments from about 20° C. to about 110° C.

### Polymer Characteristics Prior to Modification

The reactive polymers may be characterized by their molecular weight, which may include number average molecular weight (Mn), weight average molecular weight (Mw), and peak molecular weight (Mp). As those skilled in the art will appreciate, molecular weight can be determined by using gel permeation chromatography (GPC) using appropriate calibration standards equipped with a suitable detector such as refractive index and/or ultraviolet detector. For purposes of this specification, GPC measurements employ polystyrene standards and polystyrene Mark Houwink constants unless otherwise specified. Percent coupling may also be determined by GPC by measuring the area under the base peak (A) and the total area under the GPC curve (B). Percent coupling is then calculated as:

$$percent coupling = ( B - A ) / A \times 100 \% .$$

According to embodiments of the invention, the molecular weight of the base polymer can be increased while remaining within desired rheological properties (e.g. Mooney viscosities) given that it has been observed that the functionalizing agents of the present invention result in less coupling, particularly coupling of three or more chains together.

In one or more embodiments, the reactive polymers have an Mp, which may also be referred to as the base Mp, of greater than 160 kg/mol, in other embodiments greater than 180 kg/mol, in other embodiments greater than 200 kg/mol, in other embodiments greater than 215 kg/mol, in other embodiments greater than 230 kg/mol, in other embodiments greater than 240 kg/mol, in other embodiments greater than 250 kg/mol, in other embodiments greater than 260 kg/mol, and in other embodiments greater than 270 kg/mol. In these or other embodiments, the reactive polymers have an Mp of less 370 kg/mol, in other embodiments less than 360 kg/mol, in other embodiments less than 350 kg/mol, in other embodiments less than 330 kg/mol, in other embodiments less than 310 kg/mol, in other and in other embodiments less than 280 kg/mol, and in other embodiments less than 250 kg/mol. In one or more embodiments, the reactive polymers have an Mp of from about 160 to about 280 kg/mol, in other embodiments from about 170 to about 260 kg/mol, in other embodiments from about 200 to about 370 kg/mol, in other embodiments from about 215 to about 360 kg/mol, in other embodiments from about 230 to about 350 kg/mol, and in other embodiments from about 180 to about 250 kg/mol.

In one or more embodiments, the reactive polymers have an Mn, which may also be referred to as the base Mn, of greater than 130 kg/mol, in other embodiments greater than 140 kg/mol, in other embodiments greater than 150 kg/mol, in other embodiments greater than 170 kg/mol, in other embodiments greater than 200 kg/mol, in other embodiments greater than 210 kg/mol, in other embodiments greater than 220 kg/mol, and in other embodiments greater than 230 kg/mol. In these or other embodiments, the reactive polymers have an Mn of less than 350 kg/mol, in other embodiments less than 340 kg/mol, in other embodiments less than 330 kg/mol, in other embodiments less than 320 kg/mol, in other embodiments less than 300 kg/mol, in other embodiments less than 280 kg/mol, and in other embodiments less than 260 kg/mol. In one or more embodiments, the reactive polymers have an Mn of from about 130 to about 300 kg/mol, in other embodiments from about 140 to about 280 kg/mol, in other embodiments from about 170 to about 350 kg/mol, in other embodiments from about 200 to about 340 kg/mol, in other embodiments from about 210 to about 330 kg/mol, and in other embodiments from about 150 to about 260 kg/mol.

In one or more embodiments, the reactive polymers have an Mw, which may also be referred to as the base Mw, of greater than 180 kg/mol, in other embodiments greater than 190 kg/mol, in other embodiments greater than 200 kg/mol, in other embodiments greater than 230 kg/mol, in other embodiments greater than 245 kg/mol, in other embodiments greater than 260 kg/mol, in other embodiments greater than 275 kg/mol, and in other embodiments greater than 285 kg/mol. In these or other embodiments, the reactive polymers have an Mw of less than 650 kg/mol, in other embodiments 600 kg/mol, in other embodiments less than 550 kg/mol, in other embodiments less than 500 kg/mol, and in other embodiments less than 450 kg/mol. In one or more embodiments, the reactive polymers have an Mw of from about 180 to about 650 kg/mol, in other embodiments from about 190 to about 600 kg/mol, in other embodiments from about 200 to about 550 kg/mol, in other embodiments from about 230 to about 500 kg/mol, in other embodiments from about 250 to about 500 kg/mol, and in other embodiments from about 200 to about 400 kg/mol.

The reactive polymers produced according to aspects of the present invention may be characterized by vinyl content, which may be described as the number of unsaturations in the 1,2-microstructure relative to the total unsaturations within the polymer chain. As the skilled person will appreciate, vinyl content can be determined by FTIR analysis. In one or more embodiments, the reactive polymers include greater than 10%, in other embodiments greater than 20%, and in other embodiments greater than 35% vinyl. In these or other embodiments, the reactive polymers include less than 80%, in other embodiments less than 60%, and in other embodiments less than 46%. In one or more embodiments, the reactive polymers include from about 10 to about 80%, in other embodiments from about 20 to about 60%, and in other embodiments from about 35 to about 46% vinyl.

The reactive polymers may be characterized by a relatively high live (also referred to as reactive) end content, which represents the mole % of polymers that have reactive chain ends are capable of reacting with a functionalizing agent. In one or more embodiments, at greater than 60%, in other embodiments greater than 70%, in other embodiments greater than 80%, in other embodiments greater than 85%, in other embodiments greater than 90%, and in other embodiments greater than 90% of the polymers in the polymerization mixture contain a living or reactive chain end.

### Polymer Modification

As indicated above, following polymerization, the reactive polymer undergoes modification, which may also be referred to as functionalization. That is, the reactive end of the polymer is modified, which may also be referred to as functionalized, by introducing an imine-containing dihydrocarbyloxy silane compound to the polymerization mixture. It is believed that the polymer chain end reacts with the imine-containing hydrocarbyloxy silane (which for purposes of this specification may be referred to as a functionalizing or modifying agent) to provide a residue of the functionalizing agent at the end of the polymer chain. In particular, it is believed that an appreciable portion of the functionalization reaction takes place at the silicon atom, which thereby displaces a hydrocarbyloxy group on the imine-containing dihydrocarbyloxy silane compound. Accordingly, the reaction between the polymer and the functionalizing agent produces a polymer composition including one or more polymer chains that include a terminal group deriving from the imine-containing dihydrocarbyloxy silane. It should be appreciated that the reaction between the functionalizing agent and the reactive polymer can also result in polymer coupling. In either event, polymers bearing a chain-end functional group and polymers coupled with the residue of the functionalizing agent will both be referred to as modified or functionalized polymers unless otherwise designated.

In one or more embodiments, greater than 10 mol %, in other embodiments greater than 30 mol %, in other embodiments greater than 35 mol %, and in other embodiments greater than 40 mol % of the polymer chains within the polymer composition include the terminal functional group. In these or other embodiments, less than 95 mol %, in other embodiments less than 90 mol %, and in other embodiments less than 85 mol % of the polymer chains within the polymer composition include the terminal functional group. In one or more embodiments, from about 10 to about 95 mol %, in other embodiments from about 30 to about 90 mol %, and in other embodiments from about 35 to about 85 mol % of the polymer chains within the polymer composition include the terminal functional group.

### Dihydrocarbyloxy Functionalization Agent

As indicated above, the anionically-synthesized reactive polydienes are functionalized with an imine-containing dihydrocarbyloxy silane, which may also be referred to as an imine-containing dihydrocarbyloxysilyl functionalizing agent, an imino dihydrocarbyloxysilane, or simply as a dihydrocarbyloxysilane or a dihydrocarbyloxysilyl functionalizing agent. Since the most common hydrocarbyloxy groups are alkoxy groups, the functionalizing agents employed in the present invention may also be generally referred to using the alkoxy name (e.g. imine-containing dialkoxy silane).

In one or more embodiments, the imine-containing dihydrocarbyloxy silane functionalizing agent may be defined by the formula

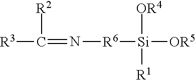

where R¹, R², R³, R⁴, and R⁵ are each individually a hydrocarbyl group, and R⁶ is a dihydrocarbyl group.

Examples of these imino group-containing alkoxysilane compounds include 3-(1-hexamethyleneimino)propyl(diethoxy)methylsilane, 3-(1-hexamethyleneimino)propyl(dimethoxy)methylsilane, (1-hexamethyleneimino)methyl(dimethoxy)methylsilane, (1-hexamethyleneimino)methyl(diethoxy)methylsilane, 2-(1-hexamethyleneimino)ethyl(diethoxy)methylsilane, 2-(1-hexamethyleneimino)ethyl(dimethoxy)methylsilane, 3-(1-pyrrolidinyl)propyl(diethoxy)methylsilane, 3-(1-pyrrolidinyl)propyl(dimethoxy)methylsilane, 3-(1-heptamethyleneimino)propyl(diethoxy)methylsilane, 3-(1-dodecamethyleneimino)propyl(diethoxy)methylsilane, 3-(1-hexamethyleneimino)propyl(diethoxy)ethylsilane, 3-(1-hexamethyleneimino)propyl(dimethoxy)ethylsilane, N-(1,3-dimethylbutylidene)-3-(diethoxysilyl)methyl-1-propaneamine, N-(1-methylethylidene)-3-(diethoxysilyl)methyl-1-propaneamine, N-ethylidene-3-(diethoxysilyl)methyl-1-propaneamine, N-(1-methylpropylidene)-3-(diethoxysilyl)methyl-1-propaneamine, N-(4-N,N-dimethylaminobenzylidene)-3-(diethoxysilyl)methyl-1-propaneamine, N-(cyclohexylidene)-3-(diethoxysilyl)methyl 1-propaneamine, (dimethoxy)propylsilyl compounds, (diethoxy)propylsilyl compounds, (diethoxy)ethylsilyl compounds, (dimethoxy)methylsilyl compounds and (dimethoxy)butylsilyl compounds corresponding to these triethoxysilyl compounds, 1-[3-(diethoxymethylsilyl)propyl]-4,5-dihydroimidazole, 1-[3-(dimethoxymethylsilyl)propyl]-4,5-dihydroimidazole, 3-[10-(diethoxymethylsilyl)decyl]-4-oxazoline, 3-(1-hexamethyleneimino)propyl(diethoxy)methylsilane, (1-hexamethyleneimino)methyl(dimethoxy)methylsilane, N-(3-(diethoxy)methylsilylpropyl)-4,5-dihydroimidazole, N-(3-isopropoxysilylpropyl)-4,5-dihydroimidazole, and N-(3-methyldiethoxysilylpropyl)-4,5-dihydroimidazole.

### Amount of Dialkoxy Functionalization Agent Used

The amount of functionalizing agent (i.e., imine-containing hydrocarbyloxy silane) employed in the practice of the present invention can be described with respect to the lithium or metal cation associated with the initiator. In one or more embodiments, the amount of functionalizing agent introduced to the polymerization mixture is greater than 0.40, in other embodiments greater than 0.50, in other embodiments greater than 0.60, in other embodiments greater than 0.65, in other embodiments greater than 0.70, and in other embodiments greater than 0.75 moles of functionalizing agent per mole of lithium in the initiator. In these or other embodiments, less than 0.98, in other embodiments less than 0.95, in other embodiments less than 0.90, in other embodiments less than 0.85, in other embodiments less than 0.80, in other embodiments less than 0.75, and in other embodiments less than 0.70 moles of functionalizing agent per mole of lithium is introduced to the polymerization mixture. In one or more embodiments, from about 0.60 to about 0.90, in other embodiments from about 0.65 to about 0.85, and in other embodiments from about 0.70 to about 0.80 moles of functionalizing agent per mole of lithium is introduced to the polymerization mixture.

In one or more embodiments, the amount of functionalizing agent (i.e., imine-containing hydrocarbyloxy silane) employed in the practice of the present invention can be described relative to the moles of reactive polymer. In one or more embodiments, the molar ratio of functionalizing agent to reactive polymer (i.e. polydiene or polydiene copolymer) is greater than 0.50:1, in other embodiments greater than 0.60:1, in other embodiments greater than 0.65:1, in other embodiments greater than 0.70:1, and in other embodiments greater than 0.75:1 moles of functionalizing agent per mole of lithium in the initiator. In these or other embodiments, molar ratio of functionalizing agent to reactive polymer is less than 1:1, in other embodiments less than 0.98, in other embodiments less than 0.95, in other embodiments less than 0.90, and in other embodiments less than 0.88. In one or more embodiments, molar ratio of functionalizing agent to reactive polymer is from about 0.60:1 to about 1:1, in other embodiments from about 0.7:1 to about 0.98:1, and in other embodiments from about 0.75:1 to about 0.95:1.

In one or more embodiments, the reaction between the functionalizing agent and the reactive polymer may take place at a temperature from about 10° C. to about 150° C., and in other embodiments from about 20° C. to about 100° C. The time required for completing the reaction between the functionalizing agent and the reactive polymer depends on various factors such as the type and amount of the catalyst or initiator used to prepare the reactive polymer, the type and amount of the functionalizing agent, as well as the temperature at which the functionalization reaction is conducted. In one or more embodiments, the reaction between the functionalizing agent and the reactive polymer can be conducted for about 10 to 60 minutes.

In one or more embodiments, the functionalizing agent is introduced to the polymer cement (i.e. polymerization mixture) while the polymer is dissolved or suspended within a solvent. As those skilled in the art appreciate, this solution may be referred to as a polymer cement. In one or more embodiments, the characteristics of the polymer cement, such as its concentration, will be the same or similar to the characteristics of the cement prior to functionalization.

In one or more embodiments, modification of the polymer (i.e., introduction of the functionalizing agent to the polymer cement), takes place within the same vessel in which the polymerization was conducted. In other embodiments, modification of the polymer takes place outside of the reaction vessel in which the polymerization takes place. For example, a functionalizing agent can be introduced to the polymerization mixture (i.e., polymer cement) in a downstream vessel or a downstream transfer conduit.

### Polymer Stabilization

As indicated above, following modification, the modified polymer may be stabilized. In one or more embodiments, stabilizing agents known in the art may be used. For example, the stabilizing agents may include an alkyl hydrocarbyloxy silane (e.g. alkylalkoxy silanes) as disclosed in U.S. Pat. No. 6,255,404, which is incorporated herein by reference. Exemplary alkylalkoxy silanes include octyltriethoxy silane. In other embodiments, the stabilizing agent may include long-chain alcohols as disclosed in U.S. Pat. No. 6,279,632, which is incorporated herein by reference. Exemplary long chain alcohols include sorbitan stearate or sorbitan momoleate. In still other embodiments, the polymers may be stabilized by treatment with an alkylalkoxy silane followed by treatment with a silane including a hydrolyzable group that forms an acidic species upon hydrolysis, such as methyltrichlorosilane, as disclosed in U.S. Pat. No. 9,546,237, which is incorporated herein by reference.

In one or more embodiments, the modified polymer may be stabilized by introducing an alkyl hydrocarbyloxy silane to the polymerization mixture including the modified polymer. It is believed that the alkyl hydrocarbyloxy silane reacts with the terminal functional group. It also believed that the reaction between the chain end functional group and the alkyl hydrocarbyloxy silane takes place at the introduction of the two molecules or after aging of the composition. The reaction between the alkyl hydrocarbyloxy silane and the terminal group produces a polymer composition including one or more polymer chains that include a terminal group deriving from the imine-containing dihydrocarbyloxy silane and subsequent reaction with an alkyl hydrocarbyloxy silane.

In one or more embodiments, the stabilizing agent is a hydrocarbyl hydrocarbyloxy silane (i.e. stabilizing agent) that may be defined by the formula I:

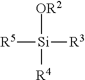

where R² is a hydrocarbyl group, R³, R⁴, and R⁵ are each independently a hydrocarbyl group or a hydrocarbyloxy group. In particular embodiments, R³, R⁴, and R⁵ are hydrocarbyl groups. In other embodiments, R³ and R⁴ are hydrocarbyl groups and R⁵ is a hydrocarbyloxy group. In other embodiments, R³ is a hydrocarbyl group and R⁴ and R⁵ are hydrocarbyloxy groups. In certain embodiments, R³, R⁴, and R⁵ are all hydrocarbyloxy groups.

In one or more embodiments, the hydrocarbyl groups of the hydrocarbyl hydrocarbyloxy silane include, but are not limited to, alkyl, cycloalkyl, substituted cycloalkyl, alkenyl, cycloalkenyl, substituted cycloalkenyl, aryl, allyl, substituted aryl, aralkyl, alkaryl, or alkynyl groups. Substituted hydrocarbyl groups include hydrocarbyl groups in which one or more hydrogen atoms have been replaced by a substituent such as an alkyl group. In one or more embodiments, the hydrocarbyl groups may include from one, or the appropriate minimum number of carbon atoms to form the group, to 20 carbon atoms. These hydrocarbyl groups may contain heteroatoms such as, but not limited to, nitrogen, boron, oxygen, silicon, sulfur, and phosphorus atoms.

In one or more embodiments, the hydrocarbyloxy groups of the hydrocarbyl hydrocarbyloxy silane include, but are not limited to, alkoxy, cycloalkoxy, substituted cycloalkoxy, alkenyloxy, cycloalkenyloxy, substituted cycloalkenyloxy, aryloxy, allyloxy, substituted aryloxy, aralkyloxy, alkaryloxy, or alkynyloxy groups. Substituted hydrocarbyloxy groups include hydrocarbyloxy groups in which one or more hydrogen atoms attached to a carbon atom have been replaced by a substituent such as an alkyl group. In one or more embodiments, the hydrocarbyloxy groups may include from one, or the appropriate minimum number of carbon atoms to form the group, to 20 carbon atoms. The hydrocarbyloxy groups may contain heteroatoms such as, but not limited to nitrogen, boron, oxygen, silicon, sulfur, and phosphorus atoms.

In one or more embodiments, types of hydrocarbyl hydrocarbyloxy silane include trihydrocarbyl hydrocarbyloxy silanes, dihydrocarbyl dihydrocarbyloxy silanes, hydrocarbyl trihydrocarbyloxy silanes, and tetrahydrocarbyloxy silanes.

Specific examples of hydrocarbyl trihydrocarbyloxy silanes include methyltrimethoxysilane, ethyltrimethoxysilane, propyltrimethoxysilane, phenyltrimethoxysilane, octyltrimethoxysilane, decyltrimethoxysilane, methyltriethoxysilane, ethyltriethoxysilane, propyltriethoxysilane, phenyltriethoxysilane, octyltriethoxysilane, decyltriethoxysilane, methyltriphenoxysilane, ethyltriphenoxysilane, propyltriphenoxysilane, octyltriphenoxysilane, phenyltriphenoxysilane, decyltriphenoxysilane, methyldiethoxymethoxysilane, ethyldiethoxymethoxysilane, propyldiethoxymethoxysilane, phenyldiethoxymethoxysilane, octyldiethoxymethoxysilane, decyldiethoxymethoxysilane, methyldiphenoxymethoxysilane, ethyldiphenoxymethoxysilane, propyldiphenoxymethoxysilane, phenyldiphenoxymethoxysilane, octyldiphenoxymethoxysilane, decyldiphenoxymethoxysilane, methyldimethoxyethoxysilane, ethyldimethoxyethoxysilane, propyldimethoxyethoxysilane, phenyldimethoxyethoxysilane, octyldimethoxyethoxysilane, decyldimethoxyethoxysilane, methyldiphenoxyethoxysilane, ethyldiphenoxyethoxysilane, propyldiphenoxyethoxysilane, phenyldiphenoxyethoxysilane, octyldiphenoxyethoxysilane, decyldiphenoxyethoxysilane, methyldimethoxyphenoxysilane, ethyldimethoxyphenoxysilane, propyldimethoxyphenoxysilane, phenyldimethoxyphenoxysilane, octyldimethoxyphenoxysilane, decyldimethoxyphenoxysilane, methyldiethoxyphenoxysilane, ethyldiethoxyphenoxysilane, propyldiethoxyphenoxysilane, phenyldiethoxyphenoxysilane, octyldiethoxyphenoxysilane, decyldiethoxyphenoxysilane, methylmethoxyethoxyphenoxysilane, ethylmethoxyethoxyphenoxysilane, propylmethoxyethoxyphenoxysilane, phenylmethoxyethoxyphenoxysilane, octylmethoxyethoxyphenoxysilane, and decylmethoxyethoxyphenoxysilane.

In one or more embodiments, the stabilizing agent is added to the polymer cement after a sufficient time is provided to allow completion of the reaction between the reactive polymer and the functionalizing agent. In one or more embodiments, the stabilizing agent is introduced to the polymer cement after 30 minutes, in other embodiments after 15 minutes, and in other embodiments after 10 minutes from the time that the functionalizing agent is introduced to the polymer cement.

The amount of stabilizing agent (i.e., hydrocarbyl hydrocarbyloxy silane) employed in the practice of the present invention can be described with respect to the moles of lithium associated with the initiator. In one or more embodiments, greater than 0.5, in other embodiments greater than 1, in other embodiments greater than 2, and in other embodiments greater than 3 moles of stabilizing agent per mole of lithium in the initiator is introduced to the polymerization mixture. In these or other embodiments, less than 8, in other embodiments less than 7, in other embodiments less than 6, in other embodiments less than 5, in other embodiments less than 4.5, in other embodiments less than 4, and in other embodiments less than 3.5 moles of stabilizing agent per mole of lithium is introduced to the polymerization mixture. In one or more embodiments, from about 0 to about 7, in other embodiments from about 2 to about 6, and in other embodiments from about 3 to about 5 moles of stabilizing agent per mole of lithium is introduced to the polymerization mixture. In one or more embodiments, no stabilizing agent (e.g. hydrocarbyl hydrocarbyloxy silane) is employed.

In other embodiments, the amount of stabilizing agent (i.e., hydrocarbyl hydrocarbyloxy silane) employed in the practice of the present invention can be described as a molar ratio relative to the moles of functionalizing agent employed. In one or more embodiments, the ratio of the moles of stabilizing agent to the moles of functionalizing agent employed is from about 0:1 to about 16:1, in other embodiment from about 0.5:1 to about 10:1, and in other embodiments from about 2:1 to about 8:1. In these or other embodiments, the ratio of the moles of stabilizing agent to the moles of functionalizing agent employed is less than 16:1, in other embodiments less than 10:1, in other embodiments less than 8:1, in other embodiments less than 5:1, and in other embodiments less than 4.5:1.

In one or more embodiments, the stabilization of the polymer (i.e., introduction of the stabilizing agent) takes place within the same vessel in which the polymerization took place. In these embodiments, this will include the same vessel in which the modification took place. In other embodiments, stabilization of the polymer (i.e., introduction of the stabilizing agent) takes place outside of the vessel in which the polymerization took place. Likewise, in one or more embodiments, stabilization of the polymer takes place outside of the vessel in which the modification of the polymer took place. For example, in one or more embodiments, the stabilizing agent can be added to the polymerization mixture (i.e., polymer cement) in a vessel or transfer line that is downstream of the vessel in which the polymerization took place and that is downstream of the vessel in which the polymer modification took place. For purposes of this specification, relative to the polymerization vessel, the vessel or conduit in which the stabilizing agent is introduced may be referred to as a second vessel or second reaction zone. In other embodiments, the stabilizing agent may be introduced to the polymer while the polymer is suspended or dissolved within monomer.

### Antioxidant

In one or more embodiments, after the introduction of the functionalizing agent to the reactive polymer, optionally after the addition of a quenching agent and/or antioxidant, optionally after or together with the stabilizing agent, and optionally after recovery or isolation of the functionalized polymer, an antioxidant can be added to the polymerization mixture. Exemplary antioxidants include 2,6-di-tert-butyl-4-methylphenol.

In one or more embodiments, after formation of the polymer, a processing aid and other optional additives such as oil can be added to the polymer cement.

### Optional Quenching

In one or more embodiments, after the reaction between the reactive polymer and the functionalizing agent has been accomplished or completed, a quenching agent can be added to the polymerization mixture in order to inactivate any residual reactive polymer chains and the catalyst or catalyst components. The quenching agent may include a protic compound, which includes, but is not limited to, an alcohol, a carboxylic acid, an inorganic acid, water, or a mixture thereof. The amount of quenching agent employed may be in the range of 0.5 to 10 moles of quenching agent per mole of lithium used to initiate the polymerization.

### Condensation Accelerator

In one or more embodiments, after the introduction of the functionalizing agent to the reactive polymer, optionally after the addition of a quenching agent and/or antioxidant, optionally after or together with the stabilizing agent, and optionally after recovery or isolation of the functionalized polymer, a condensation accelerator can be added to the polymerization mixture. Useful condensation accelerators include tin and/or titanium carboxylates and tin and/or titanium alkoxides. One specific example is titanium 2-ethylhexyl oxide. Useful condensation catalysts and their use are disclosed in U.S. Publication No. 2005/0159554 (Patent No. U.S. Pat. No. 7,683,151), which is incorporated herein by reference. In other embodiments, an organic acid can be used as a condensation accelerator. Useful types of organic acids include aliphatic, cycloaliphatic and aromatic monocarboxylic, dicarboxylic, tricarboxylic and tetracarboxylic acids. Specific examples of useful organic acids include, but are not limited to, acetic acid, propionic acid, butyric acid, hexanoic acid, 2-methylhexanoic acid, 2-ethylhexanoic acid, cyclohexanoic acid and benzoic acid.

The amount of condensation accelerator employed in the practice of the present invention can be described with respect to the moles of lithium associated with the initiator. In one or more embodiments, the moles of condensation accelerator per mole of lithium is greater than 1.0, in other embodiments greater than 1.5, and in other embodiments greater than 1.8 moles of condensation accelerator per mole of lithium in the initiator. In these or other embodiments, less than 4.0, in other embodiments less than 3.3, and in other embodiments less than 3.0 moles of condensation accelerator per mole of lithium is introduced to the polymerization mixture. In one or more embodiments, from about 1.0 to about 4.0, in other embodiments from about 1.5 to about 3.3, and in other embodiments from about 1.8 to about 3.0 moles of condensation accelerator per mole of lithium is introduced to the polymerization mixture.

### Polymer Desolventization

As indicated above, following optional stabilization and following introduction of an optional condensation accelerator and/or an antioxidant, the polymer product (e.g., the stabilized, functionalized polymer) undergoes separation from the solvent, which may be referred to as desolventization. In other words, as described above, the polymers are synthesized in an organic solvent, and during the step of desolventization, the organic solvent is separated from the polymer.

In particular embodiments, desolventization includes hot water and/or steam coagulation. For example, the polymerization mixture, which includes the modified polymer, can be combined with a steam or hot water stream. The heat associated with the steam or hot water stream volatilizes the solvent and any unreacted monomer. The polymer product is then dispersed within an aqueous phase in, for example, the form of polymer crumb. The nature and size of the polymer crumb can generally be manipulated by the introduction of mechanical energy (e.g. in the form of mixers).

In one or more embodiments, the polymer crumb is temporarily stored as a crumb dispersion within the water until subsequent drying steps, which are described below. The crumb dispersion is generally a mixture of polymer particles or crumb and water. The polymer particles, which may also be referred to as coagulated polymer, are generally on the macroscale and have at least on dimension that is greater than one mm. This crumb dispersion may be contained within a tank, such as a conventional reactor tank such as a continuously stirred tank reactor.

In one or more embodiments, the polymer crumb can be further processed to remove residual solvent and dry the polymer (i.e., separate the polymer from the water). In practicing the present invention, the polymer can be dried by using conventional techniques, which may include one or more of filtering, pressing, and heating. Following desolventization and drying, the volatile content of the dried polymer can be below 2.0%, in other embodiments below 1.0%, and in other embodiments below 0.5% by weight of the polymer.

In other embodiments, the polymer product can be desolventized by employing devolatilizers, which are extruder-type devices that can operate in conjunction with heat and/or vacuum. In yet other embodiments, the polymerization mixture can be directly drum dried.

Regardless of the methods used to desolventize and dry the polymer, the finished polymer product may be referred to as a dried polymer. Using conventional techniques, the dried polymer can be molded or otherwise manipulated into a bale.

### Polymer Characteristics of Dried Polymer

In one or more embodiments, the dried, unaged functionalized polymers of the present invention are characterized by an advantageous Mooney viscosity (ML₁+4@100° C.). Specifically, in one or more embodiments, the polymers, within 24 hours of desolventization and drying, have a Mooney viscosity (ML₁+4@100° C.) of less than 95, in other embodiments less than 90, and in other embodiments less than 85. In these or other embodiments, the polymers, within 24 hours of desolventization and drying, have a Mooney viscosity (ML₁+4@100° C.) of from about 35 to about 120, in other embodiments from about 55 to about 95, in other embodiments from about 60 to about 90, and in other embodiments from about 65 to about 85. For purposes of this specification, the dried, unaged Mooney viscosity (ML₁+4@100° C.) may be referred to as the Mooney viscosity of the bale.

### Polymer Characteristics of Aged Polymer

As indicated above, the functionalized polymers of the present invention are characterized by an advantageous aged Mooney viscosity (ML₁+4@100° C.). Specifically, in one or more embodiments, the polymers, when aged for two years after desolventization and drying, have a Mooney viscosity (ML₁+4@100° C.) of less than 120, in other embodiments less than 105, and in other embodiments less than 95. In one or more embodiments, polymers, when aged for two years after desolventization and drying, have a Mooney viscosity (ML₁+4@100° C.) of from about 70 to about 120, in other embodiments from about 80 to about 105, and in other embodiments from about 85 to about 95. For purposes of this specification, and specifically with regard to the two-year aged Mooney viscosity, accelerated aging can be undertaken at 100° C. for two days in lieu of two years of room temperature aging. In other words, for purposes of this specification, the two aging methods are treated equivalently relative to the viscosity obtained.

### INDUSTRIAL APPLICABILITY

In one or more embodiments, the functionalized polydiene and polydiene copolymers of the invention may be used in formulating vulcanizable rubber composition that may, for example, be useful in the preparation of tire components. Rubber compounding techniques and the additives employed therein are generally disclosed in The Compounding and Vulcanization of Rubber, in Rubber Technology (2^{nd} Ed. 1973).

Generally speaking, these vulcanizable rubber compositions include a vulcanizable rubber component, reinforcing filler, and a curative or curative system. These compositions may also optionally include metal activators, resins, and processing oils, as well the various ingredients that may be conventionally included in these vulcanizable rubber compositions.

### Ingredients of Vulcanizable Composition

In one or more embodiments, the stabilized, functionalized polydiene or polydiene copolymers of this invention may form all or part of the rubber component of the vulcanizable compositions. That is, the rubber component may include other vulcanizable rubbers, which may also be referred to as elastomeric polymers or simply elastomers.

The rubber compositions can be prepared by using the polymers of this invention alone or together with other elastomers (i.e., polymers that can be vulcanized to form compositions possessing rubbery or elastomeric properties). Other elastomers that may be used include natural and synthetic rubbers. The synthetic rubbers typically derive from the polymerization of conjugated diene monomers, the copolymerization of conjugated diene monomers with other monomers such as vinyl-substituted aromatic monomers, or the copolymerization of ethylene with one or more α-olefins and optionally one or more diene monomers.

Exemplary elastomers include natural rubber, synthetic polyisoprene, polybutadiene, polyisobutylene-co-isoprene, neoprene, poly(ethylene-co-propylene), poly(styrene-co-butadiene), poly(styrene-co-isoprene), poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, and mixtures thereof. These elastomers can have a myriad of macromolecular structures including linear, branched, and star-shaped structures.

The rubber compositions may include fillers such as inorganic and organic fillers. Examples of organic fillers include carbon black and starch. Examples of inorganic fillers include silica, aluminum hydroxide, magnesium hydroxide, mica, talc (hydrated magnesium silicate), and clays (hydrated aluminum silicates). Carbon blacks and silicas are the most common fillers used in manufacturing tires. In certain embodiments, a mixture of different fillers may be advantageously employed.

In one or more embodiments, carbon blacks include furnace blacks, channel blacks, and lamp blacks. More specific examples of carbon blacks include super abrasion furnace blacks, intermediate super abrasion furnace blacks, high abrasion furnace blacks, fast extrusion furnace blacks, fine furnace blacks, semi-reinforcing furnace blacks, medium processing channel blacks, hard processing channel blacks, conducting channel blacks, and acetylene blacks.

In particular embodiments, the carbon blacks may have a surface area (EMSA) of at least 20 m²/g and in other embodiments at least 35 m²/g; surface area values can be determined by ASTM D-1765 using the cetyltrimethylammonium bromide (CTAB) technique. The carbon blacks may be in a pelletized form or an unpelletized flocculent form. The preferred form of carbon black may depend upon the type of mixing equipment used to mix the rubber compound.

Some commercially available silicas which may be used include Hi-Sil™ 215, Hi-Sil™ 233, and Hi-Sil™ 190 (PPG Industries, Inc.; Pittsburgh, PA). Other suppliers of commercially available silica include Grace Davison (Baltimore, MD), Degussa Corp. (Parsippany, NJ), Rhodia Silica Systems (Cranbury, NJ), and J.M. Huber Corp. (Edison, NJ).

In one or more embodiments, silicas may be characterized by their surface areas, which give a measure of their reinforcing character. The Brunauer, Emmet and Teller (“BET”) method (described in J. Am. Chem. Soc., 1939, vol. 60, 2 p. 309-319) is a recognized method for determining the surface area. The BET surface area of silica is generally less than 450 m²/g. Useful ranges of surface area include from about 32 to about 400 m²/g, about 100 to about 250 m²/g, and about 150 to about 220 m²/g.

The pH's of the silicas are generally from about 5 to about 7 or slightly over 7, or in other embodiments from about 5.5 to about 6.8.

In one or more embodiments, where silica is employed as a filler (alone or in combination with other fillers), a coupling agent and/or a shielding agent may be added to the rubber compositions during mixing in order to enhance the interaction of silica with the elastomers. Useful coupling agents and shielding agents are disclosed in U.S. Pat. Nos. 3,842,111; 3,873,489; 3,978,103; 3,997,581; 4,002,594; 5,580,919; 5,583,245; 5,663,396; 5,674,932; 5,684,171; 5,684,172; 5,696,197; 6,608,145; 6,667,362; 6,579,949; 6,590,017; 6,525,118; 6,342,552; and 6,683,135; which are incorporated herein by reference.

In one or more embodiments, the vulcanizable compositions of the invention may include one or more resins. As the skilled person understands, resins may include plasticizing resins and hardening or thermosetting resins. Useful plasticizing resins include hydrocarbon resins such as cycloaliphatic resins, aliphatic resins, aromatic resins, terpene resins, and combinations thereof. Useful resins are commercially available from various companies including, for example, Chemfax, Dow Chemical Company, Eastman Chemical Company, Idemitsu, Neville Chemical Company, Nippon, Polysat Inc., Resinall Corp., Pinova Inc., Yasuhara Chemical Co., Ltd., Arizona Chemical, and SI Group Inc., and Zeon under various trade names.

In one or more embodiments, useful hydrocarbon resins may be characterized by a glass transition temperature (Tg) of from about 30 to about 160° C., in other embodiments from about 35 to about 60° C., and in other embodiments from about 70 to about 110° C. In one or more embodiments, useful hydrocarbon resins may also be characterized by its softening point being higher than its Tg. In certain embodiments, useful hydrocarbon resins have a softening point of from about 70 to about 160° C., in other embodiments from about 75 to about 120° C., and in other embodiments from about 120 to about 160° C.

In certain embodiments, one or more cycloaliphatic resins are used in combination with one or more of an aliphatic, aromatic, and terpene resins. In one or more embodiments, one or more cycloaliphatic resins are employed as the major weight component (e.g. greater than 50% by weight) relative to total load of resin. For example, the resins employed include at least 55% by weight, in other embodiments at least 80% by weight, and in other embodiments at least 99% by weight of one or more cycloaliphatic resins.

In one or more embodiments, cycloaliphatic resins include both cycloaliphatic homopolymer resins and cycloaliphatic copolymer resins including those deriving from cycloaliphatic monomers, optionally in combination with one or more other (non-cycloaliphatic) monomers, with the majority by weight of all monomers being cycloaliphatic. Non-limiting examples of useful cycloaliphatic resins suitable include cyclopentadiene (“CPD”) homopolymer or copolymer resins, dicyclopentadiene (“DCPD”) homopolymer or copolymer resins, and combinations thereof. Non-limiting examples of cycloaliphatic copolymer resins include CPD/vinyl aromatic copolymer resins, DCPD/vinyl aromatic copolymer resins, CPD/terpene copolymer resins, DCPD/terpene copolymer resins, CPD/aliphatic copolymer resins (e.g. CPD/C5 fraction copolymer resins), DCPD/aliphatic copolymer resins (e.g. DCPD/C5 fraction copolymer resins), CPD/aromatic copolymer resins (e.g. CPD/C9 fraction copolymer resins), DCPD/aromatic copolymer resins (e.g. DCPD/C9 fraction copolymer resins), CPD/aromatic-aliphatic copolymer resins (e.g. CPD/C5 & C9 fraction copolymer resins), DCPD/aromatic-aliphatic copolymer resins (e.g. DCPD/C5 & C9 fraction copolymer resins), CPD/vinyl aromatic copolymer resins (e.g., CPD/styrene copolymer resins), DCPD/vinyl aromatic copolymer resins (e.g. DCPD/styrene copolymer resins), CPD/terpene copolymer resins (e.g. limonene/CPD copolymer resin), and DCPD/terpene copolymer resins (e.g. limonene/DCPD copolymer resins). In certain embodiments, the cycloaliphatic resin may include a hydrogenated form of one of the cycloaliphatic resins discussed above (i.e. a hydrogenated cycloaliphatic resin). In other embodiments, the cycloaliphatic resin excludes any hydrogenated cycloaliphatic resin; in other words, the cycloaliphatic resin is not hydrogenated.

In certain embodiments, one or more aromatic resins are used in combination with one or more of an aliphatic, cycloaliphatic, and terpene resins. In one or more embodiments, one or more aromatic resins are employed as the major weight component (e.g. greater than 50% by weight) relative to total load of resin. For example, the resins employed include at least 55% by weight, in other embodiments at least 80% by weight, and in other embodiments at least 99% by weight of one or more aromatic resins.

In one or more embodiments, aromatic resins include both aromatic homopolymer resins and aromatic copolymer resins including those deriving from one or more aromatic monomers in combination with one or more other (non-aromatic) monomers, with the largest amount of any type of monomer being aromatic. Non-limiting examples of useful aromatic resins include coumarone-indene resins and alkyl-phenol resins, as well as vinyl aromatic homopolymer or copolymer resins, such as those deriving from one or more of the following monomers: alpha-methylstyrene, styrene, ortho-methylstyrene, meta-methylstyrene, para-methylstyrene, vinyltoluene, para(tert-butyl)styrene, methoxystyrene, chlorostyrene, hydroxystyrene, vinylmesitylene, divinylbenzene, vinylnaphthalene or any vinyl aromatic monomer resulting from C9 fraction or C8-C10 fraction. Non-limiting examples of vinylaromatic copolymer resins include vinylaromatic/terpene copolymer resins (e.g. limonene/styrene copolymer resins), vinylaromatic/C5 fraction resins (e.g. C5 fraction/styrene copolymer resin), vinylaromatic/aliphatic copolymer resins (e.g. CPD/styrene copolymer resin, and DCPD/styrene copolymer resin). Non-limiting examples of alkyl-phenol resins include alkylphenol-acetylene resins such as p-tert-butylphenol-acetylene resins, alkylphenol-formaldehyde resins (such as those having a low degree of polymerization. In certain embodiments, the aromatic resin may include a hydrogenated form of one of the aromatic resins discussed above (i.e. a hydrogenated aromatic resin). In other embodiments, the aromatic resin excludes any hydrogenated aromatic resin; in other words, the aromatic resin is not hydrogenated.

In certain embodiments, one or more aliphatic resins are used in combination with one or more of cycloaliphatic, aromatic and terpene resins. In one or more embodiments, one or more aliphatic resins are employed as the major weight component (e.g. greater than 50% by weight) relative to total load of resin. For example, the resins employed include at least 55% by weight, in other embodiments at least 80% by weight, and in other embodiments at least 99% by weight of one or more aliphatic resins.

In one or more embodiments, aliphatic resins include both aliphatic homopolymer resins and aliphatic copolymer resins including those deriving from one or more aliphatic monomers in combination with one or more other (non-aliphatic) monomers, with the largest amount of any type of monomer being aliphatic. Non-limiting examples of useful aliphatic resins include C5 fraction homopolymer or copolymer resins, C5 fraction/C9 fraction copolymer resins, C5 fraction/vinyl aromatic copolymer resins (e.g. C5 fraction/styrene copolymer resin), C5 fraction/cycloaliphatic copolymer resins, C5 fraction/C9 fraction/cycloaliphatic copolymer resins, and combinations thereof. Non-limiting examples of cycloaliphatic monomers include, but are not limited to cyclopentadiene (“CPD”) and dicyclopentadiene (“DCPD”). In certain embodiments, the aliphatic resin may include a hydrogenated form of one of the aliphatic resins discussed above (i.e. a hydrogenated aliphatic resin). In other embodiments, the aliphatic resin excludes any hydrogenated aliphatic resin; in other words, in such embodiments, the aliphatic resin is not hydrogenated.

In one or more embodiments, terpene resins include both terpene homopolymer resins and terpene copolymer resins including those deriving from one or more terpene monomers in combination with one or more other (non-terpene) monomers, with the largest amount of any type of monomer being terpene. Non-limiting examples of useful terpene resins include alpha-pinene resins, beta-pinene resins, limonene resins (e.g. L-limonene, D-limonene, dipentene which is a racemic mixture of L- and D-isomers), beta-phellandrene, delta-3-carene, delta-2-carene, pinene-limonene copolymer resins, terpene-phenol resins, aromatic modified terpene resins and combinations thereof. In certain embodiments, the terpene resin may include a hydrogenated form of one of the terpene resins discussed above (i.e. a hydrogenated terpene resin). In other embodiments, the terpene resin excludes any hydrogenated terpene resin; in other words, in such embodiments, the terpene resin is not hydrogenated.

In one or more embodiments, the vulcanizable compositions of this invention include processing oils, which may also be referred to as extender oils. In one or more embodiments, the vulcanizable compositions are devoid or substantially devoid of processing oils.

In particular embodiments, the oils that are employed include those conventionally used as extender oils. Useful oils or extenders that may be employed include, but are not limited to, aromatic oils, paraffinic oils, naphthenic oils, vegetable oils other than castor oils, low PCA oils including MES, TDAE, and SRAE, and heavy naphthenic oils. Suitable low PCA oils also include various plant-sourced oils such as can be harvested from vegetables, nuts, and seeds. Non-limiting examples include, but are not limited to, soy or soybean oil, sunflower oil, safflower oil, corn oil, linseed oil, cotton seed oil, rapeseed oil, cashew oil, sesame oil, camellia oil, jojoba oil, macadamia nut oil, coconut oil, and palm oil. As is generally understood in the art, oils refer to those compounds that have a viscosity that is relatively compared to other constituents of the vulcanizable composition, such as the resins.

In one or more embodiments, oils include those hydrocarbon compounds that have greater than 15, in other embodiments greater than 20, in other embodiments greater than 25, in other embodiments greater than 30 carbon atoms, in other embodiments greater than 35 carbon atoms, and in other embodiments greater than 40 carbon atoms per molecule. In these or other embodiments, oils include those hydrocarbon compounds that have less than 250, in other embodiments less than 200, in other embodiments less than 150, in other embodiments less than 120, in other embodiments less than 100, in other embodiments less than 90, in other embodiments less than 80, in other embodiments less than 70, in other embodiments less than 60, in other embodiments less than 50 carbon atoms per molecule. In one or more embodiments, oils include those hydrocarbon compounds that have from about 15 to about 250, in other embodiments from about 20 to about 200, in other embodiments from about 25 to about 100 carbon atoms per molecule, in other embodiments from about 25 to about 70 carbon atoms per molecule, in other embodiments from about 25 to about 70 carbon atoms per molecule, in other embodiments from about 25 to about 60 carbon atoms per molecule, and in other embodiments from about 25 to about 40 carbon atoms per molecule.

In one or more embodiments, oils include those compounds that have a dynamic viscosity, at 25° C., of greater than 5, in other embodiments greater than 10, in other embodiments greater than 15, in other embodiments greater than 20, in other embodiments greater than 25, and in other embodiments greater than 30, in other embodiments greater than 35, and in other embodiments greater than 40 mPa-s. In these or other embodiments, oils include those compounds that have a dynamic viscosity, at 25° C., less than 3000, in other embodiments less than 2500, in other embodiments less than 2000, in other embodiments less than 1500, in other embodiments less than 1000, in other embodiments less than 750, in other embodiments less than 500, in other embodiments less than 250, in other embodiments less than 100, and in other embodiments less than 75 mPa-s. In one or more embodiments, oils include those compounds that have a dynamic viscosity, at 25° C., from about 5 to about 3000, in other embodiments from about 15 to about 2000, in other embodiments from about 20 to about 1500, in other embodiments from about 25 to about 1000, in other embodiments from about 30 to about 750, in other embodiments from about 35 to about 500, and in other embodiments from about 50 to about 250 mPa-s.

A multitude of rubber curing agents (also called vulcanizing agents) may be employed, including sulfur or peroxide-based curing systems. Curing agents are described in Kirk-Othmer, ENCYCLOPEDIA OF CHEMICAL TECHNOLOGY, Vol. 20, pgs. 365-468, (3^{rd} Ed. 1982), particularly Vulcanization Agents and Auxiliary Materials, pgs. 390-402, and A. Y. Coran, Vulcanization, ENCYCLOPEDIA OF POLYMER SCIENCE AND ENGINEERING, (2nd Ed. 1989), which are incorporated herein by reference. Vulcanizing agents may be used alone or in combination.

Other ingredients that are typically employed in rubber compounding may also be added to the rubber compositions. These include accelerators, accelerator activators, oils, plasticizer, waxes, scorch inhibiting agents, processing aids, zinc oxide, tackifying resins, reinforcing resins, fatty acids such as stearic acid, peptizers, and antidegradants such as antioxidants and antiozonants. In particular embodiments, the oils that are employed include those conventionally used as extender oils, which are described above.

### Ingredient Amounts

As indicated above, the vulcanizable compositions include a vulcanizable rubber component. In one or more embodiments, the vulcanizable compositions include greater than 20, in other embodiments greater than 30, and in other embodiments greater than 40 percent by weight of the vulcanizable rubber component (which may be simply be referred to as rubber component), based upon the entire weight of the composition. In these or other embodiments, the vulcanizable compositions include less than 90, in other embodiments less than 70, and in other embodiments less than 60 percent by weight of the rubber component based on the entire weight of the vulcanizable composition. In one or more embodiments, the vulcanizable compositions include from about 20 to about 90, in other embodiments from about 30 to about 70, and in other embodiments from about 40 to about 60 percent by weight of the rubber component based upon the entire weight of the vulcanizable composition.

In one or more embodiments, the rubber component of the vulcanizable compositions of this invention include greater than 10 wt %, in other embodiments greater than 30 wt %, and in other embodiments greater than 50 wt % of the functionalized polymer of this invention, with the balance including other vulcanizable rubber. In these or other embodiments, the rubber component of the vulcanizable compositions of this invention include less than 100 wt %, in other embodiments less than 90 wt %, and in other embodiments less than 80 wt % of the functionalized polymer of this invention, with the balance including other vulcanizable rubber. In one or more embodiments, the rubber component of the vulcanizable compositions of this invention include from about 10 to about 100 wt %, in other embodiments from about 30 to about 90 wt %, and in other embodiments from about 50 to about 80 wt % of the functionalized polymer of this invention, with the balance including other vulcanizable rubber.

### Filler

In one or more embodiments, the vulcanizable compositions include greater than 0, in other embodiments greater than 40, in other embodiments greater than 60, in other embodiments greater than 80, in other embodiments greater than 90, in other embodiments greater than 100, and in other embodiments greater than 110 parts by weight (pbw) of filler per 100 parts by weight rubber (phr). In these or other embodiments, the vulcanizable composition includes less than 200, in other embodiments less than 160, in other embodiments less than 150, and in other embodiments less than 140 pbw of filler phr. In one or more embodiments, the vulcanizable composition includes from about 40 to about 200, in other embodiments from about 60 to about 160, and in other embodiments from about 100 to about 150 pbw of filler phr.

### Carbon Black

In one or more embodiments, the vulcanizable compositions include greater than 0, in other embodiments greater than 1, in other embodiments greater than 2, in other embodiments greater than 5, in other embodiments greater than 10, and in other embodiments greater than 15 parts by weight (pbw) of a carbon black per 100 parts by weight rubber (phr). In these or other embodiments, the vulcanizable composition includes less than 60, in other embodiments less than 40, and in other embodiments less than 30 pbw of a carbon black phr. In one or more embodiments, the vulcanizable composition includes from about 1 to about 60, in other embodiments from about 5 to about 50, and in other embodiments from about 10 to about 40 pbw of a carbon black phr. In one or more embodiments, the vulcanizable compositions are devoid or substantially devoid of carbon black.

### Silica

In one or more embodiments, the vulcanizable compositions include greater than 5, in other embodiments greater than 40, in other embodiments greater than 60, in other embodiments greater than 70, in other embodiments greater than 80, in other embodiments greater than 90, in other embodiments greater than 100, and in other embodiments greater than 110 parts by weight (pbw) silica per 100 parts by weight rubber (phr). In these or other embodiments, the vulcanizable composition includes less than 140, in other embodiments less than 130, in other embodiments less than 120, in other embodiments less than 120, and in other embodiments less than 100 pbw of silica phr. In one or more embodiments, the vulcanizable composition includes from about 40 to about 140, in other embodiments from about 60 to about 130, and in other embodiments from about 80 to about 120 pbw of silica phr.

### Filler Ratio

In one or more embodiments, the vulcanizable compositions can be characterized by the ratio of silica to other filler compounds such as carbon black. In one or more embodiments, silica is used in excess relative to the other fillers such as carbon black. In one or more embodiments, the ratio of the amount of silica to carbon black, based upon a weight ratio, is greater than 1:1, in other embodiments greater than 2:1, in other embodiments greater than 3:1, and in other embodiments greater than 5:1. In one or more embodiments, the weight ratio of silica to carbon black is from about 1:1 to about 30:1, in other embodiments from about 2.1 to about 20:1, and in other embodiments from about 3:1 to about 10:1.

### Silica Coupling Agent

In one or more embodiments, the vulcanizable compositions include greater than 1, in other embodiments greater than 2, and in other embodiments greater than 5 parts by weight (pbw) silica coupling agent per 100 parts by weight silica. In these or other embodiments, the vulcanizable composition includes less than 20, in other embodiments less than 15, and in other embodiments less than 10 pbw of the silica coupling agent per 100 parts by weight silica. In one or more embodiments, the vulcanizable composition includes from about 1 to about 20, in other embodiments from about 2 to about 15, and in other embodiments from about 5 to about 10 pbw of silica coupling agent per 100 parts by weight silica. In one or more embodiments, the vulcanizable compositions are devoid or substantially devoid of silica coupling agents.

### Plasticizing Resin

In one or more embodiments, the vulcanizable compositions include greater than 0.1, in other embodiments greater than 0.5, in other embodiments greater than 1.0, in other embodiments greater than 1.5, in other embodiments greater than 15, and in other embodiments greater than 25 parts by weight (pbw) of plasticizing resin (e.g. hydrocarbon resin) per 100 parts by weight rubber (phr). In these or other embodiments, the vulcanizable composition includes less than 150, in other embodiments less than 120, in other embodiments less than 90, in other embodiments less than 80, in other embodiments less than 60, in other embodiments less than 45, in other embodiments less than 15, in other embodiments less than 10, and in other embodiments less than 3.0 pbw of plasticizing resin (e.g. hydrocarbon resin) phr. In one or more embodiments, the vulcanizable composition includes from about 1 to about 150, in other embodiments from about 0.5 to about 15, in other embodiments from about 1 to about 10, in other embodiments from about 1.5 to about 3, in other embodiments from about 15 to about 100, and in other embodiments from about 25 to about 80 pbw of plasticizing resin (e.g. hydrocarbon resin) phr. In one or more embodiments, the vulcanizable compositions are devoid or substantially devoid of plasticizing resin.

### Processing/Extender Oils

In one or more embodiments, the vulcanizable compositions include greater than 0.1, in other embodiments greater than 0.5, in other embodiments greater than 1, in other embodiments greater than 1.5, and in other embodiments greater than 2 parts by weight (pbw) of a processing oil (e.g. naphthenic oil) per 100 parts by weight rubber (phr). In these or other embodiments, the vulcanizable composition includes less than 20, in other embodiments less than 18, in other embodiments less than 15, in other embodiments less than 12, in other embodiments less than 10, and in other embodiments less than 8, in other embodiments less than 5, and in other embodiments less than 3 pbw of a processing oil phr. In one or more embodiments, the vulcanizable composition includes from about 0.1 to about 20, in other embodiments from about 0.5 to about 18, in other embodiments from about 0.5 to about 15, in other embodiments from about 1 to about 10, in other embodiments from about 0.5 to about 18, in other embodiments from about 1.5 to about 3.0, and in other embodiments from about 2 to about 12 pbw of oil phr. In one or more embodiments, the vulcanizable compositions are devoid or substantially devoid of oils.

### Plasticizing Additives

In one or more embodiments, the plasticizing resin and processing oils may be collectively referred to as plasticizing additives, plasticizing ingredients, plasticizing constituents, or plasticizing system. In one or more embodiments, the vulcanizable compositions of this invention include greater than 0.5, in other embodiments greater than 1, and in other embodiments greater than 1.5 parts by weight (pbw) of plasticizing additives per 100 parts by weight rubber (phr). In these or other embodiments, the vulcanizable composition includes less than 15, in other embodiments less than 12, in other embodiments less than 10, in other embodiments less than 5, and in other embodiments less than 3 pbw of plasticizing additives phr. In one or more embodiments, the vulcanizable composition includes from about 0.5 to about 15, in other embodiments from about 1 to about 10, and in other embodiments from about 1.5 to about 3 pbw of plasticizing additives phr.

### Hardening Resins

In one or more embodiments, the vulcanizable composition includes less than 2, in other embodiments less than 1, in other embodiments less than 0.5 pbw hardening resin phr. In one or more embodiments, the vulcanizable composition includes from about 0.1 to about 8, in other embodiments from about 0.5 to about 6, and in other embodiments from about 2 to about 4 pbw hardening resin phr. In one or more embodiments, the vulcanizable compositions are devoid or substantially hardening resins.

### Sulfur

In one or more embodiments, the vulcanizable compositions include sulfur as the curative. In one or more embodiments, the vulcanizable compositions include greater than 0.1, in other embodiments greater than 0.3, and in other embodiments greater than 0.9 parts by weight (pbw) of sulfur per 100 parts by weight rubber (phr). In these or other embodiments, the vulcanizable compositions includes less than 6, in other embodiments less than 4, in other embodiments less than 3.0, and in other embodiments less than 2.0 pbw of sulfur phr. In one or more embodiments, the vulcanizable composition includes from about 0.1 to about 5.0, in other embodiments from about 0.8 to about 2.5, in other embodiments from about 1 to about 2.0, and in other embodiments from about 1.0 to about 1.8 pbw of sulfur phr.

### Vulcanizable Composition Processing

In one or more embodiments, vulcanizable compositions are prepared by mixing a vulcanizable rubber and filler to form a masterbatch, and then the curative is subsequently added to the masterbatch. The preparation of the masterbatch may take place using one or more sub-mixing steps where, for example, one or more ingredients may be added to the composition sequentially after an initial mixture is prepared by mixing two or more ingredients. Also, using conventional technology, additional ingredients can be added in the preparation of the vulcanizable compositions such as, but not limited to, carbon black, additional fillers, silica, silica coupling agent, silica dispersing agent, processing oils, processing aids such as zinc oxide and fatty acid, and antidegradants such as antioxidants or antiozonants.

### Mixing Conditions

In one or more embodiments, the various constituents of the rubber component (e.g. the rubber component and the filler) are introduced to the vulcanizable rubber as an initial ingredient in the formation of a rubber masterbatch, optionally with carbon black and silica filler. As a result, these constituents undergo high shear, high temperature mixing. In one or more embodiments, this masterbatch mixing step takes place at minimum temperatures in excess of 110° C., in other embodiments in excess of 130° C., and in other embodiments in excess of 150° C. In one or more embodiments, high shear, high temperature mixing takes place at a temperature from about 110° C. to about 170° C. In one or more embodiments, the masterbatch mixing step, or one or more sub-steps of the masterbatch mixing step, may be characterized by the peak temperature obtained by the composition during the mixing. This peak temperature may also be referred to as a drop temperature. In one or more embodiments, the peak temperature of the composition during the masterbatch mixing step may be at least 140° C., in other embodiments at least 150° C., and in other embodiments at least 160° C. In these or other embodiments, the peak temperature of the composition during the masterbatch mixing step may be from about 140 to about 200° C., in other embodiments from about 150 to about 190° C., and in other embodiments from about 160 to about 180° C.

Following the initial mixing, the composition (i.e. masterbatch) is cooled to a temperature of less than 100° C., or in other embodiments less than 80° C., and a curative is added. In certain embodiments, mixing is continued at a temperature of from about 90 to about 110° C., or in other embodiments from about 95 to about 105° C., to prepare the final vulcanizable composition. Following the masterbatch mixing step, a curative or curative system is introduced to the composition and mixing is continued to ultimately form the vulcanizable composition of matter. This mixing step may be referred to as the final mixing step, the curative mixing step, or the productive mixing step. The resultant product from this mixing step may be referred to as the vulcanizable composition.

In one or more embodiments, the final mixing step may be characterized by the peak temperature obtained by the composition during final mixing. As the skilled person will recognize, this temperature may also be referred to as the final drop temperature. In one or more embodiments, the peak temperature of the composition during final mixing may be at most 130° C., in other embodiments at most 110° C., and in other embodiments at most 100° C. In these or other embodiments, the peak temperature of the composition during final mixing may be from about 80 to about 130° C., in other embodiments from about 90 to about 115° C., and in other embodiments from about 95 to about 105° C.

The mixing procedures and conditions particularly applicable to silica-filled tire formulations are described in U.S. Pat. Nos. 5,227,425; 5,719,207; and 5,717,022, as well as European Patent No. 890,606, all of which are incorporated herein by reference. In one embodiment, the initial masterbatch is prepared by including the polymer and silica in the substantial absence of coupling agents and shielding agents.

### Mixing Equipment

All ingredients of the vulcanizable compositions can be mixed with standard mixing equipment such as internal mixers (e.g. Banbury or Brabender mixers), extruders, kneaders, and two-rolled mills. Mixing can take place singularly or in tandem. As suggested above, the ingredients can be mixed in a single stage, or in other embodiments in two or more stages. For example, in a first stage (i.e. mixing stage), which typically includes the rubber component and filler, a masterbatch is prepared. Once the masterbatch is prepared, the vulcanizing agents may be introduced and mixed into the masterbatch in a final mixing stage, which is typically conducted at relatively low temperatures so as to reduce the chances of premature vulcanization. Additional mixing stages, sometimes called remills, can be employed between the masterbatch mixing stage and the final mixing stage.

According to embodiments of the present invention, the use of the functionalized polymer of the present invention offers an unexpected advantage of reduced alcohol generation (as a volatile) during rubber processing; e.g. less ethanol is generated as a volatile during the rubber mixing steps. According to embodiments of the invention, the amount of alcohol (e.g. ethanol) liberated from the functionalized polymers of the present invention is less than 5.0, in other embodiments less than 4.0, in other embodiments less than 3.5, and in other embodiments less than 3.0 mmol of ethanol per kilogram of polymer processed, excluding any alcohol (e.g. ethanol) generated from the silane coupling agents. Furthermore, in view of the reduced loading of stabilizer required in order to process the functionalized polymer of the present invention (i.e. the amount of alkoxy silane the must be introduced to the functionalized polymer as a stabilizing agent), the overall volatile alcohol released during polymer processing is further reduced. According to embodiments of the present invention, the total volatile alcohol generated during rubber mixing, which volatile alcohol derives from the functionalized polymer and the stabilizing agent, is less than 110, in other embodiments less than 95, in other embodiments less than 80, and in other embodiments less than 70 mmol of ethanol per kilogram of polymer processed excluding any alcohol (e.g. ethanol) generated from the silane coupling agents.

### Preparation of Tire

The vulcanizable compositions can be processed into tire components according to ordinary tire manufacturing techniques including standard rubber shaping, molding and curing techniques. Typically, vulcanization is effected by heating the vulcanizable composition in a mold; e.g. it may be heated to about 140° C. to about 180° C. Cured or crosslinked rubber compositions may be referred to as vulcanizates, which generally contain three-dimensional polymeric networks that are thermoset. The other ingredients, such as fillers and processing aids, may be evenly dispersed throughout the crosslinked network. Pneumatic tires can be made as discussed in U.S. Pat. Nos. 5,866,171, 5,876,527, 5,931,211, and 5,971,046, which are incorporated herein by reference.

### INDUSTRIAL APPLICABILITY

As indicated above, the vulcanizable compositions of the present invention can be cured to prepare various tire components. These tire components include, without limitation, tire treads, tire sidewalls, belt skims, innerliners, ply skims, and bead apex. These tire components can be included within a variety of vehicle tires including passenger tires.

The rubber compositions prepared from the polymers of this invention are particularly useful for forming tire components such as treads, subtreads, sidewalls, body ply skims, bead filler, and the like. In one or more embodiments, these tread or sidewall formulations may include from about 10% to about 100% by weight, in other embodiments from about 35% to about 90% by weight, and in other embodiments from about 50% to about 80% by weight of the polymer of this invention based on the total weight of the rubber within the formulation.

### EXAMPLES

In order to demonstrate the practice of the present invention, the following examples have been prepared and tested. The examples should not, however, be viewed as limiting the scope of the invention. The claims will serve to define the invention.

Samples were prepared in a 378.5 liter reactor equipped with a heating/cooling jacket and agitator blades. Butyl lithium was used to anionically initiate the random polymerization of butadiene and styrene with hexanes within a polymerization mixture that included about 17 wt % monomer. The targeted base molecular weight was 215 kg/mol (polystyrene standard), which was achieved based upon the butyl lithium charge. The ratio of styrene to butadiene was adjusted to achieve polymers with 10 wt % styrene with a balance of butadiene. The vinyl content was targeted at 41.5 wt % of the butadiene mer units, which was achieved by using 2,2-di(tetrahydrofuryl)propane as a vinyl modifier.

A reactive polymer cement was prepared by using about 64 kg of hexane, about 11 kg of about 35 wt % weight styrene in hexane, and about 155 kg of about 23 wt % weight butadiene in hexane were initially charged to the reactor, and then 1.5 kg of 3 wt % butyl lithium was added followed by 0.012 kg of 2,2-di(tetrahydrofuryl)propane and 0.013 kg of potassium tert-amylate. The monomer and solvent were charged to the reactor at room temperature, agitated, and heated to a stabilized temperature of 33° C. External heating was then discontinued and the butyl lithium initiator was charged form a polymerization mixture. The polymerization mixture was allowed to exothermically peak, which generally occurred at about 23 minutes from butyl lithium charge, and the polymerization mixture was thermostated at about 85° C. using a cooling jacket. A polymer samples was pulled from the polymerization mixture and introduced into a one liter bottle and combined with about 10 mL of isopropanol and about 10 mL of a 10% solution of butylated hydroxytoluene (BHT).

Within about 5 minutes of the peak polymerization temperature, the reactor was charged with a functionalizing agent of the type and in the amounts provided in Table I. The polymerization mixture was continually agitated for about 30 minutes, and then ethylhexanoic acid (EHA) (about 0.092 kg) was added to the reactor, followed by octyltriethoxysilane (OTES), which is about 4.0 equivalents of OTES per equivalent of lithium associated with the lithium initiator. Then, 0.252 kg of butylated hydroxytoluene (BHT) was charged followed by about 0.023 kg of isopropanol. The functionalizing agents were 3-(1,3 dimethylbutylidene)aminopropyltriethoxysilane (3-EOS) and 3-(1,3 dimethylbutylidene)aminopropylmethyldiethoxysilane (2-EOS). At this point in the process, samples were extracted for analysis of peak molecular weight by GPC with polystyrene standards and polystyrene Mark Houwink constants (which analysis was also used to determine % Coupling), as well as Mooney viscosity (ML₁+4@100° C.). Glass transition temperature (Tg) was measured by differential scanning calorimetry (DSC) over the range of −120° C. to 23° C. with a 10° C./min heating rate. Vinyl microstructure of the butadiene content (1,2-microstructure) and styrene content was determined by infrared. Total nitrogen analysis was performed on (3×) coagulated samples using Mitsubishi Chemical Analytech NSX-2100 Elemental Analyzer System.

Polymer analyzed at this point in the process may be referred to as “blend tank” (e.g., blend tank Mooney). For purposes of this specification and invention, blend tank Mooney and Mooney at desolventization are deemed to be equivalent.

The polymerization mixture was then transferred to a water-based desolventization process. Specifically, a tank including water was heated to a temperature of about 82° C. The polymerization mixture was slowly added to this tank, which caused the hexanes to volatilize; the volatiles were collected within a condenser. The polymer coagulated in the presence of the water to form a coagulated polymer dispersion. The polymer was then dewatered by passing the polymer-water mixture through a grinder (i.e. a single screw extruder equipped with a perforated die). The dewatered polymer was then dried in an oven at 71° C. for one hour and then heated in the oven at 60° C. until dry (e.g. a water content of less than about 0.5 wt %). Following drying, the polymer was baled and Mooney viscosity (ML₁+4@100° C.) was measured to provide Bale Raw Mooney. Samples of the bale were aged by placing them in an oven for 48 hours at 100° C. The Mooney viscosity (ML₁+4@100° C.) of these aged samples was then measured.

Polymer Mooney viscosities were determined using a Monsanto Mooney viscometer. The ML(1+4) values were measured on a large rotor at 100° C. for 4 mins with a 1 min warm up time.

TABLE I

| Sample | 1 | 2 | 3 | 4 | 5 |
|---|---|---|---|---|---|
| Functionalizing Agent | 3-EOS | 2-EOS | 2-EOS | 2-EOS | 2-EOS |
| Amount of | 0.60 | 0.60 | 0.65 | 0.70 | 0.75 |
| Functionalizing | | | | | |
| Agent (Equiv:Li) | | | | | |
| Styrene (wt %) | 11.09 | 9.56 | 11.54 | 11.11 | 11.23 |
| Vinyl (mol %) | 42.6 | 42.1 | 42.4 | 42.5 | 42.3 |
| Base Mp (kg/mol) | 214 | 218 | 217 | 217 | 215 |
| Coupling (%) | 52.9 | 52.9 | 48.3 | 48.9 | 54.9 |
| Tg (° C.) | −59.99 | −61.78 | −59.72 | −59.88 | −60.40 |
| Total Nitrogen | 63.12 | 62.47 | 65.88 | 71.84 | 77.43 |
| Bale Raw ML4 | 102.5 | 54.9 | 70.7 | 61.8 | 62.6 |
| Aged ML4 | 150.3 | 62.5 | 81.3 | 79.4 | 75.7 |

The vulcanizable compositions were prepared within a 300 g Brabender mixer by using a three stage mix procedure as shown in Table II. The remill did not include that additional of any ingredients. The masterbatch stage was mixed with a starting mixer temperature of 90° C. at 50 rpm and was mixed for 5 minutes or until the sample reached 160° C., whichever occurred first. The remill stage was mixed with a starting mixer temperature of 90° C. at 50 rpm and was mixed for 3.0 minutes or until the sample reached 160° C., whichever occurred first. The final stage was mixed with a starting mixer temperature of 60° C. at 40 rpm and was mixed for 2.5 minutes or until the sample reached 100° C., whichever occurred first.

TABLE II

| | |
|---|---|
| Ingredient | Phr |

Master

| | |
|---|---|
| Functionalized Polymer | 80 |
| Natural Rubber | 20 |
| Carbon Black | 5 |
| Silica | 50 |
| Silane Coupling Agent | 5 |
| Stearic Acid | 2 |
| Oil | 10 |

Remill
Final

| | |
|---|---|
| Zinc Oxide | 2.5 |
| Accelerant | 4.9 |
| Sulfur | 1.5 |

The vulcanizable compositions were subjected to Mooney analysis. Samples were cured at 145° C. for 33 minutes and subjected to analysis for mechanical and dynamic properties. The mechanical properties were tested in accordance with ASTM D412 and the dynamic properties were tested using a dynamic analyzer. The results of the analysis are set forth in Table III.

TABLE III

| Sample | 1 | 2 | 3 | 4 | 5 |
|---|---|---|---|---|---|
| Functionalizing Agent | 3-EOS | 2-EOS | 2-EOS | 2-EOS | 2-EOS |
| Amount of | 0.60 | 0.60 | 0.65 | 0.70 | 0.75 |
| Functionalizing | | | | | |
| Agent (Equiv:Li) | | | | | |
| Tensile Strength (MPa) | 12.3 | 12.8 | 13.7 | 11.4 | 11.2 |
| (RT) | | | | | |
| Elongation at Break (%) | 248 | 272 | 284 | 256 | 247 |
| tan δ @ 65° C. | 0.087 | 0.069 | 0.072 | 0.077 | 0.071 |
| ΔG′ (MPa) | 0.969 | 0.431 | 0.374 | 0.442 | 0.366 |

Various modifications and alterations that do not depart from the scope and spirit of this invention will become apparent to those skilled in the art. This invention is not to be duly limited to the illustrative embodiments set forth herein.

1. A polymeric composition comprising:
a plurality of hydrocarbyloxysilyl-terminated polydienes or polydiene copolymers, the polymeric composition having an aged Mooney (ML₁₊₄ @100° C.) of about 40 to about 105, where the polymeric composition includes from about 10 to about 95 mole % of said hydrocarbyloxysilyl-terminated polydienes or polydiene copolymers, where said hydrocarbyloxysilyl-terminated polydienes or polydiene copolymers are formed by reacting reactive polydienes or polydiene copolymers with a terminating agent defined by the formula: 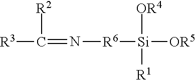
where R¹, R², R³, R⁴, and R⁵ are each individually a hydrocarbyl group, and R⁶ is a dihydrocarbyl group.

2. The composition of claim 1, where said hydrocarbyloxysilyl-terminated polymers are further formed by treating the plurality of hydrocarbyloxysilyl-terminated polydienes or polydiene copolymers with a stabilizing agent after said step of reacting the reactive polydienes or polydiene copolymers with a terminating agent.

3. The composition ofany of claim 2, where the stabilizing agent is an alkyl hydrocarbyloxy silane.

4. The composition ofany of claim 1, where the reactive polydienes or polydiene copolymers are prepared with a lithium-based initiator, where said plurality of hydrocarbyloxysilyl-terminated polydienes or polydiene copolymers is treated with less than 6 moles of stabilizing agent per mole of lithium associated with the lithium initiator.

5. A method for preparing a functionalized polydiene or polydiene copolymer polymeric composition, the method comprising reacting reactive polydienes or polydiene copolymers with a terminating agent defined by the formula: 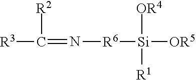
where R¹, R², R³, R⁴, and R⁵ are each individually a hydrocarbyl group, and R⁶ is a dihydrocarbyl group to thereby form a functionalized polydienes or polydiene copolymers.

6. The method of claim 5, where the functionalized polydienes or polydiene copolymers are treated with a stabilizing agent after said step of reacting the reactive polydienes or polydiene copolymers with a terminating agent.

7. The method of claim 6, where the reactive polydienes or polydiene copolymers are formed by anionically polymerizing 1,3-butadiene, optionally together with monomer copolymerizable therewith, in the presence of a lithium-based initiator, to form said reactive polydienes or polydiene copolymers.

8. The method of claim 7, where said step of anionically polymerizing reaches a peak polymerization temperature of from about −10° C. to about 200° C.

9. The method of claim 5, where said reactive polydienes or polydiene copolymers form a polymerization mixture, and where the polymerization mixture includes greater than 75 mole % reactive polydienes or polydiene copolymers based on the total amount of polydienes or polydiene copolymers.

10. The method of claim 5, where the terminating agent is reacted with the reactive polydienes or polydiene copolymers at a molar ratio of from about 0.60:1 to about 1:1.

11. The method of an of claim 7, where the stabilizing agent is a low molecular weight hydrocarbyl hydrocarbyloxysilane.

12. The method of claim 11, where the molar ratio of the moles of hydrocarbyl hydrocarbyloxysilane to the moles of lithium associated with the lithium-based initiators is less than 5:1.

13. The method of claim 5, where said step of reacting the reactive polydienes or polydiene copolymers with a terminating agent results in modifying greater than 70 mole percent of the reactive polydienes or polydiene copolymers.

14. The method of claim 5, where said polymeric composition has an unaged Mooney (ML₁₊₄@100° C.) of about 35 to about 120.

15. The method of claim 5, where said reactive polydienes or polydiene copolymers have an Mp of from about 160 to about 280 kg/mol, and where said reactive polydienes or polydiene copolymers have an Mn of greater than 200 kg/mol.

16. (canceled)

17. The method of claim 7, where the amount of terminating agent employed is greater than 0.5 mole of terminating agent per mole of lithium in the lithium-containing initiator, and where the amount of terminating agent employed is less than 0.95 mole of terminating agent per mole of lithium in the lithium-containing initiator.

18. (canceled)

19. A vulcanizable rubber composition comprising:
(i) a functionalized polydiene or polydiene copolymer of prepared by reacting reactive polydienes or polydiene copolymers with a terminating agent;
(ii) a silica filler; and
(iii) a curative.

20. The composition of claim 19, where the vulcanizable rubber composition includes a vulcanizable rubber component, and where the vulcanizable rubber component includes greater than 10 wt % of the functionalized polydiene or polydiene copolymer.

21. The composition of claim 20, where the vulcanizable rubber composition includes greater than 40 parts by weight silica filler per 100 parts by weight of the rubber component.

22. The composition of claim 19, where the vulcanizable rubber composition is prepared by generating less than 110 mmol of ethanol per kilogram of rubber excluding any alcohol generated by any silane coupling agents within the vulcanizable composition.

23. (canceled)

24. (canceled)
